(19) United States
(12) Patent Application Publication
(10) Pub. No.: US 2011/0293242 A1
(43) Pub. Date: Dec. 1, 2011

(54) RECORDING APPARATUS, REPRODUCING APPARATUS, RECORDING/REPRODUCING SYSTEM, RECORDING MEDIUM, AND PROGRAM

(75) Inventors: Kazuki MATOBA, Tokyo (JP); Takeshi Yamauchi, Chiba (JP)

(73) Assignee: Sony Corporation, Tokyo (JP)

(21) Appl. No.: 13/109,272

(22) Filed: May 17, 2011

(30) Foreign Application Priority Data
Jun. 1, 2010 (JP) 2010-126019

(51) Int. Cl. H04N 9/80

(52) U.S. Cl. 386/241; 386/239; 386/E09.011

(57) ABSTRACT

There is provided a recording apparatus including an acquisition unit configured to acquire a video stream, a switch indication detecting unit configured to detect a switch indication with reference to the acquired video stream, the switch indication indicating switching of a content type between a 3D video content and a 2D video content, a switch information generating unit configured to, on the basis of the detected switch indication, generate switch information, the switch information indicating switching of the content type between the 3D video content and the 2D video content in the video stream, and a recording unit configured to record the switch information while correlating the switch information with the acquired video stream.

### BACKGROUND OF THE INVENTION

1. Field of the Invention

The present invention relates to a recording apparatus, a reproducing apparatus, a recording/reproducing system, a recording medium, and a program.

2. Description of the Related Art

In recent years, broadcasting has been conducted using an AV stream that contains both three-dimensional (3D) video contents and typical two-dimensional (2D) video contents. A 3D video content is, together with a 2D video content, recorded on a recording medium such as a Blu-ray Disc based on the BD-RE (Blu-ray Disc Rewritable) standard or the like for later reproduction purposes.

### SUMMARY OF THE INVENTION

Reproduction of an AV stream, however, is currently conducted while at the same time identifying the content type (a 3D video content or a 2D video content) of the recorded content. This is because it has been so far impossible to determine the type of a content to be reproduced unless video data in an AV stream is referenced. Therefore, it has been impossible for a reproducing apparatus to, before reproducing an AV stream, perform control that is necessary for the reproduction of a 3D video content in advance. Thus, a user has not been able to make preparations that are necessary for viewing the 3D video content in advance.

In light of the foregoing, it is desirable to provide a recording apparatus, a reproducing apparatus, a recording/reproducing system, a recording medium, and a program that are capable of determining if a content to be reproduced is a 3D video content or a 2D video content prior to the reproduction of a video stream.

According to a first embodiment of the present invention, there is provided a recording apparatus including an acquisition unit configured to acquire a video stream, a switch indication detecting unit configured to detect a switch indication with reference to the acquired video stream, the switch indication indicating switching of a content type between a 3D video content and a 2D video content, a switch information generating unit configured to, on the basis of the detected switch indication, generate switch information, the switch information indicating switching of the content type between the 3D video content and the 2D video content in the video stream, and a recording unit configured to record the switch information while correlating the switch information with the acquired video stream.

The switch information may include timing information for identifying a point in time of switching the content type between the 3D video content and the 2D video content from a packet number or a time stamp of the video stream.

The switch information may be recorded on a user extension area included in recording control information.

The switch information may be recorded as reproduction control information for the video stream so as to allow reproduction in which the content type is switched between the 3D video content and the 2D video content without referencing video data in the video stream.

According to a second embodiment of the present invention, there is provided a reproducing apparatus including an acquisition unit configured to acquire from a recording apparatus a video stream and switch information, the switch information indicating switching of a content type between a 3D video content and a 2D video content in the video stream, and the switch information having been generated from a switch indication detected with reference to the video stream in recording of the video stream, a reproducing unit configured to reproduce the acquired video stream, and a reproduction control unit configured to control reproduction of the acquired video stream on the basis of the switch information.

The reproducing apparatus may further include an information unit configured to inform a user of the switching of the content type between the 3D video content and the 2D video content on the basis of the switch information.

The reproduction control unit may, on the basis of the switch information, perform in advance a prerequisite process for switching the content type between the 3D video content and the 2D video content in the video stream.

The reproduction control unit may control reproduction of the video stream such that the 3D video content is reproduced on the basis of a method of displaying the 3D video content, the method being specified by the switch information.

The reproduction control unit may control reproduction of the video stream such that one of the 3D video content and the 2D video content in the video stream is reproduced on the basis of the switch information.

The reproduction control unit may control the reproduction of the video stream such that one of the 3D video content and the 2D video content in the video stream is reproduced on the basis of the ratio of content types in the video stream.

According to a third embodiment of the present invention, there is provided a recording/reproducing system including the recording apparatus according to the first embodiment of the present invention and the reproducing device according to the second embodiment of the present invention.

According to a fourth embodiment of the present invention, there is provided a recording medium including recorded thereon a video stream and switch information, the switch information having been generated from a switch indication detected with reference to the video stream in recording of the video stream, and the switch information having been recorded while being correlated with the video stream, as information indicating switching of a content type between a 3D video content and a 2D video content, so as to allow reproduction in which the content type is switched between the 3D video content and the 2D video content without referencing video data in the video stream.

According to a fifth embodiment of the present invention, there is provided a program for causing a computer to execute a recording method, the recording method including the steps of acquiring a video stream, detecting, with reference to the acquired video stream, a switch indication, the switch indication indicating switching of a content type between a 3D video content and a 2D video content, generating, on the basis of the detected switch indication, switch information, the switch information indicating switching of the content type between the 3D video content and the 2D video content in the video stream, and recording the switch information while correlating the switch information with the acquired video stream.

According to another embodiment of the present invention, there is provided a program for causing a computer to execute a reproducing method, the reproducing method including the steps of: acquiring from a recording apparatus a video stream and switch information, the switch information indicating switching of a content type between a 3D video content and a 2D video content in the video stream, and the switch information having been generated from a switch indication detected with reference to the video stream in recording of the video stream, reproducing the acquired video stream, and controlling, in the reproducing step, reproduction of the acquired video stream on the basis of the switch information.

According to the embodiments of the present invention described above, a recording apparatus, a reproducing apparatus, a recording/reproducing system, a recording medium, and a program can be provided that are capable of determining if a content to be reproduced is a 3D video content or a 2D video content prior to the reproduction of a video stream.

### BRIEF DESCRIPTION OF THE DRAWINGS

FIG. 1 is a diagram showing an AV system in accordance with one embodiment of the present invention;

FIG. 2 is a block diagram showing the configuration of an AV system in accordance with one embodiment of the present invention;

FIG. 3 is a diagram showing the directory and file structure of a BDAV format;

FIG. 4 is a diagram showing the correlation between data files in the BDAV format;

FIG. 5 is a flowchart showing the procedures of a recording/reproducing method in accordance with one embodiment of the present invention;

FIG. 6 is a diagram showing the directory and file structure of an AVCHD format; and

FIG. 7 is a diagram showing the correlation between data files in the AVCHD format.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### [1. Configuration of a Recording/Reproducing System]

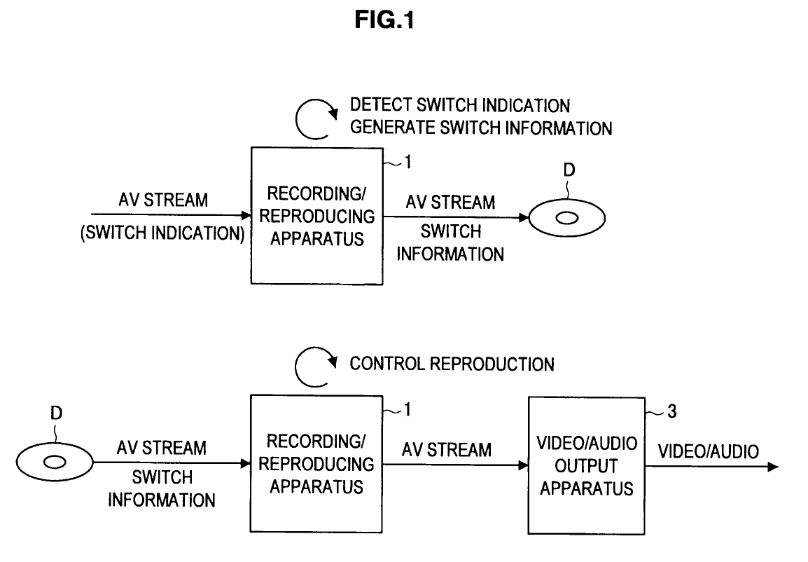

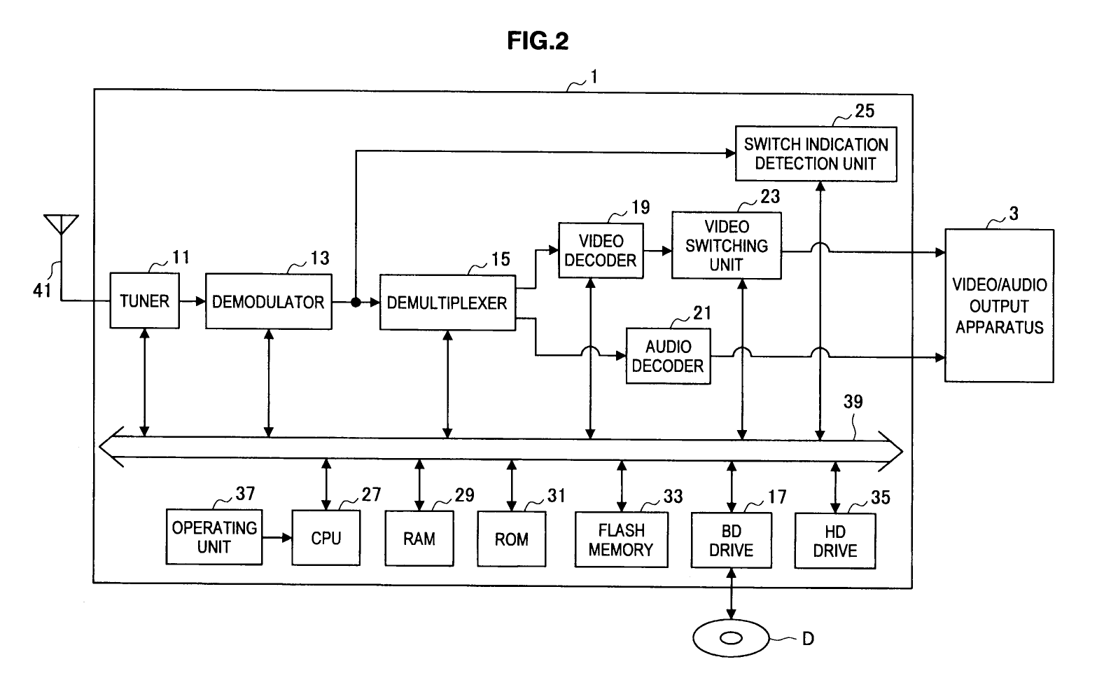

First, the configuration of a recording/reproducing system in accordance with one embodiment of the present invention will be described with reference to FIGS. 1 and 2.

FIG. 1 is a diagram showing an overview of an AV system in accordance with one embodiment of the present invention. The AV system includes a recording/reproducing apparatus 1 and a video/audio output apparatus 3. The recording/reproducing apparatus 1 as a recording apparatus receives an AV stream of a digital broadcast signal, and records video/audio data in the AV stream on a disc D. Meanwhile, the recording/reproducing apparatus 1 as a reproducing apparatus reproduces the video/audio data in the AV stream from the disc D, and outputs the data to the video/audio output apparatus 3.

The recording/reproducing apparatus 1 can be either a disc recording/reproducing apparatus 1 for a Blu-ray Disc D or a set-top box. In addition, the recording/reproducing apparatus 1 can be separated into a recording apparatus and a reproducing apparatus. Meanwhile, the video/audio output apparatus 3 can be either a television receiver or a projector, and can be separated into a video output apparatus and an audio output apparatus or be integrated with the recording/reproducing apparatus 1.

The recording/reproducing apparatus 1 receives an AV stream containing a 3D video content or a 2D video content. The AV stream also contains a switch indication that indicates switching of a content type between the 3D video content and the 2D video content. The recording/reproducing apparatus 1 detects the switch indication by referencing the received AV stream. Then, the recording/reproducing apparatus 1, on the basis of the detected switch indication, generates switch information that indicates switching of the content type between the 3D video content and the 2D video content in the AV stream, and records the switch information on a disc D while correlating the switch information with the received AV stream.

The recording/reproducing apparatus 1 reads from the disc D the AV stream and the switch information that have been recorded while being mutually correlated with each other. Then, the recording/reproducing apparatus 1 reproduces the acquired AV stream. Herein, the recording/reproducing apparatus 1 controls reproduction of the acquired AV stream on the basis of the switch information that indicates switching of the content type between the 3D video content and the 2D video content in the AV stream. Then, the recording/reproducing apparatus 1 outputs the reproduced video/audio of the AV stream to the video/audio output apparatus 3.

The disc D has, as information indicating switching of the content type between the 3D video content and the 2D video content, switch information recorded on the disc D while being correlated with the AV stream, the switch information having been generated from the switch indication detected with reference to the AV stream in the recording of the AV stream. When such a disc D is reproduced with the recording/reproducing apparatus 1, it becomes possible to perform reproduction in which the content type is switched between the 3D video content and the 2D video content without referencing the video data in the AV stream.

FIG. 2 shows the primary configuration of the recording/reproducing apparatus 1 shown in FIG. 1. The recording/reproducing apparatus 1 includes a tuner 11, a demodulator 13, a demultiplexer 15, a BD drive 17, a video decoder 19, an audio decoder 21, a video switching unit 23, a switch indication detection unit 25, a CPU 27, RAM 29, ROM 31, flash memory 33, a HD drive 35, and an operating unit 37. Components other than the operating unit 37 are connected to a bus 39. An antenna 41 is connected to the recording/reproducing apparatus 1 via the tuner 11, and the video/audio output apparatus 3 is also connected to the recording/reproducing apparatus 1 via the video switching unit 23 and the audio decoder 21.

Note that each component shown in FIG. 2 can be constructed as either hardware such as a circuit, or software such as a program executed on the CPU 27. Note that the program can be either provided using a computer-readable medium or provided via a communication means.

The tuner 11 selects a predetermined broadcast signal from among digital broadcast signals received via the antenna 41, and supplies the signal to the demodulator 13. The demodulator 13 converts the predetermined broadcast signal into an AV stream, and supplies the AV stream to the demultiplexer 15 and the switch indication detection unit 25. The tuner 11 and the demodulator 13 both function as an acquisition unit for acquiring a video stream. The demultiplexer 15 separates the AV stream into video data and audio data. The AV stream is, when recorded, supplied from the demodulator 13 to the BD drive 17, and when a video is viewed, supplied from the BD drive 17 to the demultiplexer 15. The demultiplexer 15 functions as an acquisition unit for acquiring the recorded video stream.

The BD drive 17, when a stream is recorded, writes the AV stream supplied from the demodulator 13 as video/audio data to a disc D that complies with the BD-R/RE standards or the like, in accordance with a format such as BDAV (Blu-ray Disc Audio/Visual) described below. Meanwhile, the BD drive 17, when the stream is reproduced, reads the video/audio data from the disc D, and supplies the data to the demultiplexer 15. The BD drive 17, in cooperation with the CPU 27, functions as a recording unit and a reproducing unit.

The video decoder 19 decodes the video data supplied from the demultiplexer 15 to generate a video signal, and supplies the video signal to the video switching unit 23. The audio decoder 21 decodes the audio data supplied from the demultiplexer 15 to generate an audio signal, and supplies the audio signal to a speaker (not shown) of the video/audio output apparatus 3. The video switching unit 23 executes as appropriate a process of switching a content type between a 2D video content and a 3D video content to the video signal supplied from the video decoder 19, and supplies the resulting signal to a display (not shown) of the video/audio output apparatus 3.

The CPU 27 performs arithmetic processing and control that are necessary to operate the recording/reproducing apparatus 1. The CPU 27 reads programs from the ROM 31 or the like, and develops the programs on the RAM 29 for execution. As described below, the CPU 27 also functions as a switch information generating unit and a reproduction control unit, and also functions as an acquisition unit for acquiring the recorded switch information. The flash memory 33 is used to record data or the like as nonvolatile memory. The HD drive 35 is used to record data or the like as an external storage device. The operating unit 37 receives an operation input from a user to control the operation of the recording/reproducing apparatus 1.

The switch indication detection unit 25, when a stream is recorded, detects a switch indication from the AV stream supplied from the demodulator 13. The switch indication has been transmitted while being embedded in the AV stream by a stream transmission apparatus that is provided in a digital broadcast station, as information that indicates switching of a content type between a 3D video content and a 2D video content.

The switch indication detection unit 25, upon detecting the switch indication, informs the CPU 27 of the detection result. The CPU 27 acquires the switch indication as well as switching point information that indicates the switching point in time. The switching point information is acquired from the demodulator 13 or the switch indication detection unit 25 as information on the source packet number or time stamp of the AV stream.

While a stream is recorded, the CPU 27 temporarily stores the switch indication and the switching point information into the RAM 29, a buffer (not shown), or the like. Upon termination of the stream recording, the CPU 27 generates switch information that indicates all switchings that occur in the AV stream. The switch information is supplied to the BD drive 17, and is recorded thereon as part of a clip information file (reproduction control information) 65 (described below) while being correlated with a stream file 67. Alternatively, while a stream is recorded, switch information can be recorded as part of the clip information file 65 without being sequentially or temporarily stored.

The switch indication contains timing information that specifies the switching point in time. The timing information can be relative information that indicates a time period from a point when the switch indication is detected till a point when the content type is switched, or absolute information that indicates the time when the content type is switched.

The switch indication can contain content type information that specifies the type of a content to be switched to (a 3D video content or a 2D video content). The content type information can be information that directly specifies a 3D video content or a 2D video content, or information that specifies switching of the content type. Note that if content types have been determined in advance when reception of a stream is started, it is possible to identify from the timing information the type of a content to be switched to. In such a case, therefore, it is possible to omit specifying a content type.

The switch indication can also contain display method information that specifies a method of displaying a 3D video content. The display method information is, for example, information for specifying a method of displaying a 3D video content, such as a side-by-side method, a top-and-bottom method, and an interleave method. In the side-by-side method, two videos with parallax are arranged side by side. In the top-and-bottom method, two videos with parallax are arranged one above the other. In the interleave method, two videos with parallax are arranged such that the videos are alternately interleaved.

The display method information can also be information that specifies a video to be displayed (a video for the right eye or a video for the left eye) when a 3D video content is reproduced as a 2D video content. When a 3D video content is reproduced, a video for the right eye and a video for the left eye are typically videos that are concurrently displayed as videos with parallax.

The BD drive 17, when a stream is recorded, writes video/audio data in the AV stream and the switch information to a disc D while mutually correlating them with each other. For example, in the BDAV format that is a video recording standard for BD-RE, the stream file 67 of video/audio data and attribute information file (the clip information file 65) of the stream are recorded while being correlated with each other.

### [2. Application to the BDAV Format]

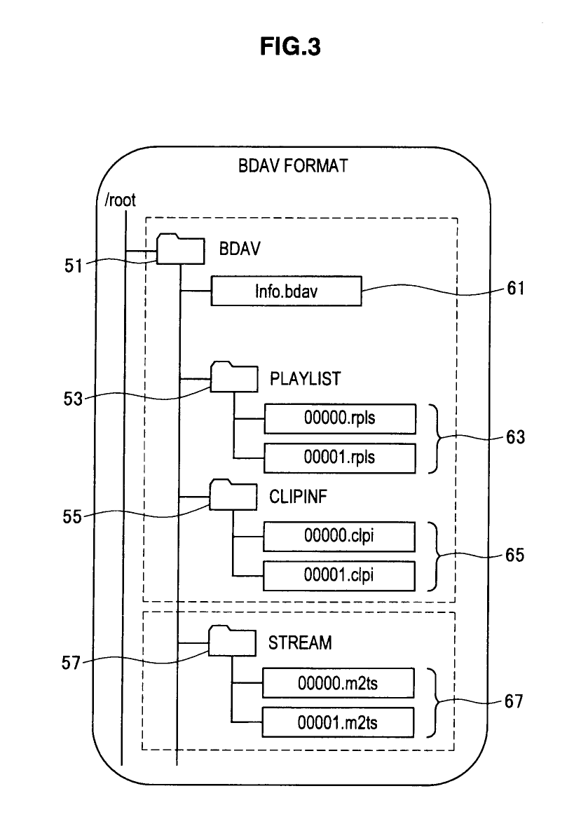

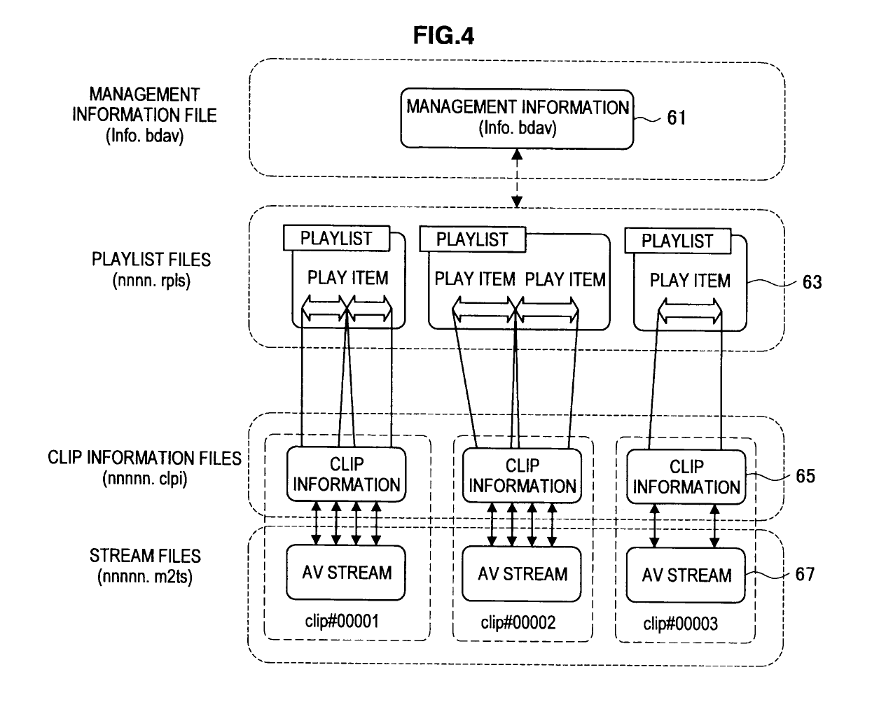

Next, a BDAV format that is a recording standard for BD recorders will be described with reference to FIGS. 3 and 4.

FIG. 3 shows the directory and file structure of the BDAV format. A “BDAV” folder 51 in the BDAV format contains database files of reproduction control information for the recorded contents, and AV stream data on the recorded contents, which are separately recorded.

As the database files, a management information file “Info.bdav” 61 is recorded, and further, a “PLAYLIST” folder 53 and a “CLIPINF” folder 55 are formed. The “PLAYLIST” folder 53 contains recorded thereon one or more playlist files 63 (nnnnn.rpls), while the “CLIPINF” folder 55 contains recorded thereon one or more clip information files 65 (nnnnn.clpi). A “STREAM” folder 57 is formed as the AV stream data, and contains recorded thereon one or more stream files 67 (nnnnn.m2ts). Note that “nnnnn” is any given identification information specified for each AV stream.

FIG. 4 shows the correlation between the data files in the BDAV format. In the BDAV format, the clip information files 65 are correlated with the stream files 67 of video/audio data, and the playlist files 63 are correlated with the clip information files 65. The playlist files 63 are managed by the management information file 61.

The clip information file 65 contains attributes and the like of an AV stream of the corresponding stream file 67. The playlist file 63 contains one or more play items that is/are specified as a predetermined data section (e.g., a data section excluding commercial contents) in the stream file 67.

For example, in FIG. 4, a playlist 1, which is defined by a clip #00001 and contains two play items, a playlist 2, which is defined by a clip #00002 and contains two play items, and a playlist 3, which is defined by a clip #00003 and contains a single play item, are managed.

The details of the clip information files 65 are standardized in the BDAV format. Each clip information file 65 has a plurality of data areas to which a specific intended use is assigned and a user extension area. Data specific to each manufacturer of the recording/reproducing apparatus 1 can be recorded on the user extension area.

The switch information is recorded, for each stream file 67 of video data, on the user extension area in the clip information file 65 corresponding to the relevant stream file 67. Note that (1) to (6) in the following format are item numbers that are provided for the sake of convenience of the description. In addition, the recording format of the switch information is not limited to the following format.

(1) 2D_3D_sequence( ){
(2) number_of_2D_3D_sequence
(3) for(i=0;i<number_of_2D_3D_sequence;i++){
(4) is_3d_area
(5) reserved
(6) start_source_packet_number

}

}

Item (1) is the header information for defining the recording of the switch information. Item (2) is information indicating the number of switchings between different content types in an AV stream. Item (3) is information for defining items (4) to (6) for each switching of the content type.

Item (4) is information (content type information) indicating the type of a content to be switched to (a 3D video content or a 2D video content), and is, for example, flag information that designates a 3D video content as “0” and designates a 2D video content as “1,” for example. Item (5) is preliminary information such as the aforementioned information used to specify a method of displaying a 3D video, or the aforementioned information used to specify a method of displaying a 3D video as a 2D video (display method information). Item (6) is information for specifying the switching point in time (switching point information), and specifies a source packet number or the like at the switching point in time. Herein, items (2), (4), (5), and (6) are recorded as information with 16 bits, 1 bit, 7 bit, and 32 bits, respectively, for example.

### [3. Procedures of the Recording/Reproducing Method]

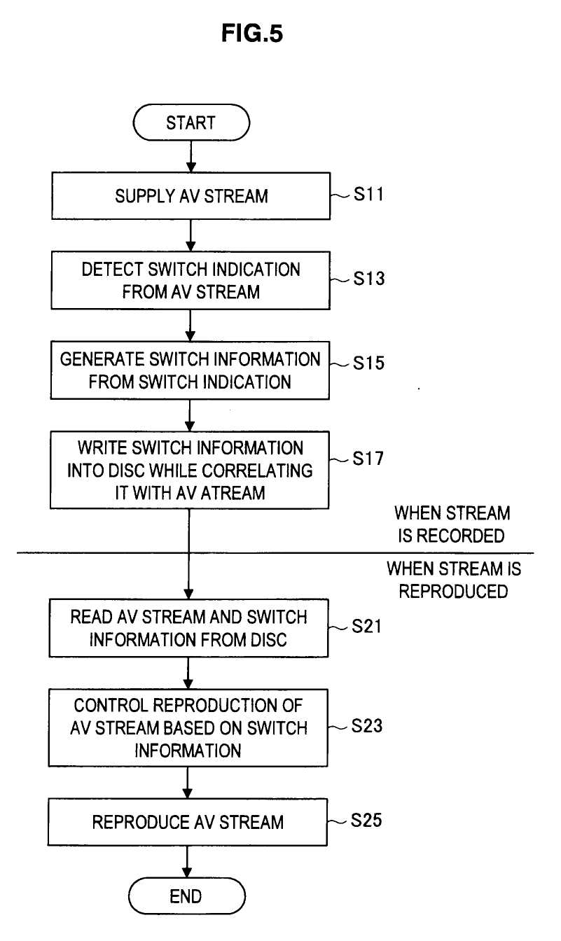

Next, the procedures of the recording/reproducing method in accordance with one embodiment of the present invention will be described with reference to FIG. 5.

As shown in FIG. 5, the demodulator 13, when a stream is recorded, supplies the AV stream to the switch indication detection unit 25 and the BD recorder (step S11). The switch indication detection unit 25 detects the switch indication from the AV stream (S13). Then, the CPU 27 (the switch information generating unit), on the basis of the detected switch indication, generates switch information, which indicates switching of a content type between a 3D video content and a 2D video content in the video stream, as the reproduction control information (S15). The BD recorder writes the switch information to a disc D while correlating the switch information with the video/audio data in the AV stream (S17).

When the stream is reproduced, the CPU 27 reads the video/audio data and the switch information from the BD recorder (S21). The switch information is read as the reproduction control information before the AV stream is reproduced. The CPU 27 controls the reproduction of the video/audio data on the basis of the switch information (S23). The video decoder 19 and the audio decoder 21 reproduce the video/audio data under the control of the CPU 27 (S25).

When a stream is reproduced, the CPU 27 (the reproduction control unit) controls the video switching unit 23 to switch the type of a content to be reproduced between a 3D video content and a 2D video content at predetermined timing, using the switching point information and the content type information.

In this case, the CPU 27 can provide a user with information for prompting him/her to make preparations that are necessary for viewing the 3D video content. Such information can be provided as a display guidance such that “The content will switch to 3D video ______ in seconds. Prepare glasses for viewing the 3D video,” or a similar audio guidance. Such information is generated by the CPU 27, and is output via the video/audio output apparatus 3.

In addition, the CPU 27 can perform control that is necessary for the reproduction of a 3D video content in advance, such as a re-authentication process for a HDMI (High-Definition Multimedia Interface). Herein, during the re-authentication for a HDMI, video cannot be displayed. A similar problem would arise if the content type cannot be identified in advance. However, such problems can be eliminated by performing control, which is necessary for the reproduction of a 3D video content in advance, on the basis of the switch information.

In addition, the CPU 27 can, when switching the content type from a 2D video content to a 3D video content, reproduce the 3D video content with a predetermined display method, using the display method information that specifies the method of displaying the 3D video content. The 3D video content is reproduced with a display method such as, for example, a side-by-side method, a top-and-bottom method, or an interleave method. Alternatively, when a 3D video content is reproduced as a 2D video content, the 3D video content can be reproduced as a video that is specified as a video for the right-eye or a video for the left eye.

Further, the CPU 27 can reproduce only one of a 3D video content and a 2D video content in the AV stream, using the switching point information and the content type information. In such a case, the type of a content to be reproduced can be specified by a user, or be automatically set by the recording/reproducing apparatus 1. Accordingly, the user can be freed from the necessity of putting on and removing the glasses for viewing a 3D video while the AV stream is reproduced.

Likewise, the CPU 27 can automatically reproduce only one of a 3D video content and a 2D video content on the basis of the ratio of the reproduction time of each content type in the AV stream. In that case, it is possible to, if the ratio of the reproduction time of a 2D video content is higher, reproduce the entire AV stream as a 2D video content using a video for the right eye or a video for the left eye, and to, if the ratio of the reproduction time of a 3D video content is higher, reproduce the entire AV stream as a 3D video content using a pseudo-3D video.

Accordingly, a user can be freed from the necessity of putting on and removing the glasses for viewing a 3D video while the AV stream is reproduced. In addition, the user can also reproduce a video of an optimal content type for each AV stream without specifying the type of a content to be reproduced.

As described above, according to the recording/reproducing apparatus 1 in accordance with one embodiment of the present invention, when a video stream is recorded, switch information, which indicates switching of a content type between a 3D video content and a 2D video content in the video stream, is recorded while being correlated with the video stream. Herein, the switch information is recorded as the reproduction control information for the video stream to allow reproduction in which the content type is switched between a 3D video content and a 2D video content, without referencing the video data in the video stream. Then, when the video stream is reproduced, the video stream and the switch information, which have been recorded while being correlated with each other, are acquired, whereby reproduction of the video stream is controlled.

Accordingly, whether a content to be reproduced is a 3D video content or a 2D video content can be determined before a video stream is reproduced. Thus, a reproducing apparatus can, before reproducing a video stream, perform control that is necessary for the reproduction of a 3D video content in advance, and a user can thus make preparations that are necessary for viewing the 3D video content in advance.

### [4. Application to the AVCHD Format]

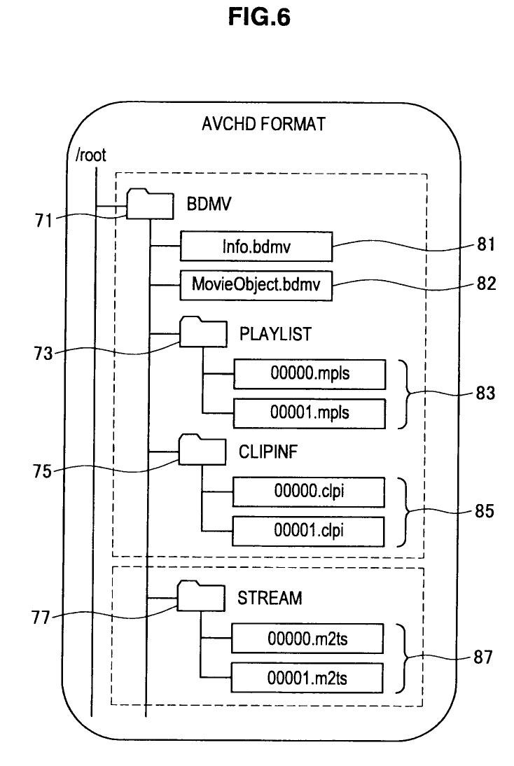

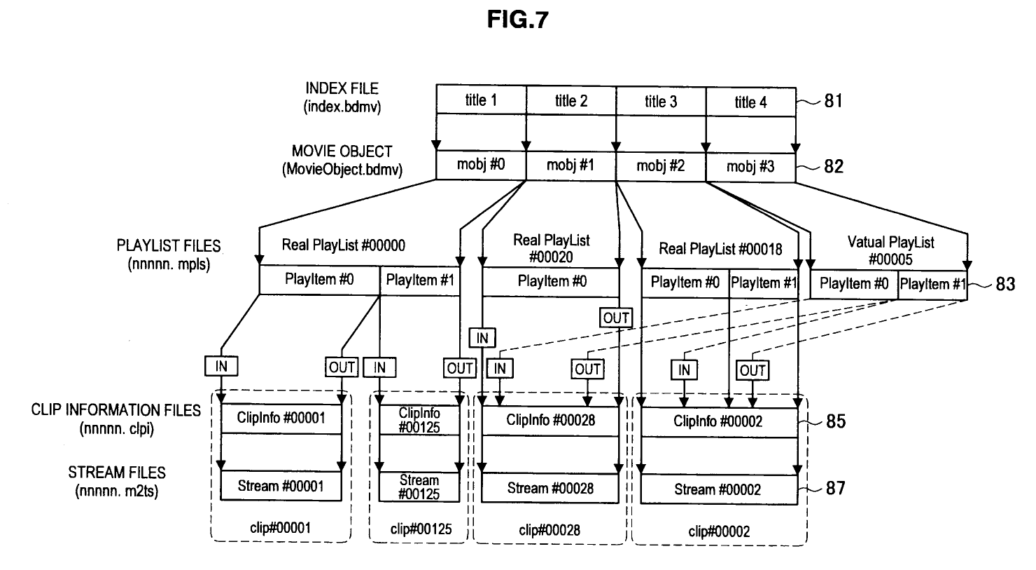

Described above is a case in which the present invention is applied to the BDAV format that is a recording standard for BD recorders. However, the present invention can also be applied to the AVCHD (Advanced Video Codec High Definition) format that is a standard for recording movies with video cameras. Next, the AVCHD format will be described with reference to FIGS. 6 and 7.

FIG. 6 shows the directory and file structure of the AVCHD format. A “BDMV” folder 71 in the AVCHD format contains database files of reproduction control information for the recorded contents, and AV stream data on the recorded contents, which are separately recorded.

As the database files, an index file 81 “Index.bdmv” and a movie object file 82 “MovieObject.bdmv” are recorded, and further, a “PLAYLIST” folder 73 and a “CLIPINF” folder 75 are formed. The “PLAYLIST” folder 73 contains recorded thereon one or more playlist files 83 (mmm.mpls), while the “CLIPINF” folder 75 contains recorded thereon one or more clip information files 85 (nnnnn.clpi). A “STREAM” folder 77 is formed as the stream data, and contains recorded thereon one or more stream files 87 (nnnnn.m2ts). Note that “nnnnn” is any given identification information specified for each AV stream.

FIG. 7 shows the correlation between the data files in the AVCHD format. In the AVCHD format, the clip information files 85 are correlated with the stream files 87 of movie data, and the playlist files 83 are correlated with the clip information files 85. The playlist files 83 are managed by the index file 81 and the movie object file 82.

The clip information file 85 contains attributes and the like of an AV stream of the corresponding stream file 87. The playlist file 83 contains one or more play items that is/are specified as a predetermined movie data section (e.g., a movie data section corresponding to a specific recorded scene) in the stream file 87.

For example, in FIG. 7, a playlist #00000, which contains a play item #0 defined by a clip #00001 and a play item #1 defined by a clip #00125, is managed as a movie object #0 to which title 1 is assigned. In addition, a playlist #00005, which contains a play item #0 defined by a clip #00028 and a play item #1 defined by a clip #00002, is managed as a movie object #3 to which title 4 is assigned.

The movie objects #0 to #2 are formed as real playlists that use movie data in units of the stream files 87. Meanwhile, the movie object #3 is formed as a virtual playlist that uses part of movie data in units of the stream files 87.

When an AV stream is recorded, a video camera generates an AV stream having embedded therein switch information that indicates switching of a content type between a 3D video content and a 2D video content. Specifically, the video camera detects switch indication from the AV stream, and generates as part of the clip information file 85 switch information that indicates switching of the content type between a 3D video content and a 2D video content. Then, the switch information is written to a disc D while being correlated with the video/audio data in the AV stream.

When the AV stream is reproduced, the video camera reads from the disc D the video/audio data as well as the switch information as part of the clip information file 85, whereby reproduction of the video/audio data is controlled on the basis of the switch information. Then, reproduction of the video/audio data is controlled such that the type of a content to be reproduced is switched between a 3D video content and a 2D video content at predetermined timing. Note that the reproduction control method used in the reproduction of the AV stream can be explained in the same way as in the case of the BDAV format.

Although the preferred embodiments of the present invention have been described in detail with reference to the appended drawings, the present invention is not limited thereto. It is obvious to those skilled in the art that various modifications or variations are possible insofar as they are within the technical scope of the appended claims or the equivalents thereof. It should be understood that such modifications or variations are also within the technical scope of the present invention.

For example, the aforementioned description has illustrated a case in which a recording/reproduction process to a disc D is performed on the recording/reproducing apparatus 1. However, the same description works for a case in which a recording process to a disc D is performed on a recording apparatus, and a reproduction process to the disc D is performed on a reproducing apparatus that is provided separately from the recording apparatus.

In addition, the aforementioned description illustrates a case in which an AV stream and switch information, which is correlated with the AV stream, are recorded as data on a disc D for later reproduction purposes. However, like data can be transmitted via a communication means instead of being recorded on the disc D for later reproduction purposes.

The present application contains subject matter related to that disclosed in Japanese Priority Patent Application JP 2010-126019 filed in the Japan Patent Office on Jun. 1, 2010, the entire content of which is hereby incorporated by reference.

What is claimed is:

1. A recording apparatus comprising:
an acquisition unit configured to acquire a video stream;
a switch indication detecting unit configured to detect a switch indication with reference to the acquired video stream, the switch indication indicating switching of a content type between a 3D video content and a 2D video content;
a switch information generating unit configured to, on the basis of the detected switch indication, generate switch information, the switch information indicating switching of the content type between the 3D video content and the 2D video content in the video stream; and
a recording unit configured to record the switch information while correlating the switch information with the acquired video stream.

2. The recording apparatus according to claim 1, wherein the switch information includes timing information for identifying a point in time of switching the content type between the 3D video content and the 2D video content from a packet number or a time stamp of the video stream.

3. The recording apparatus according to claim 1, wherein the switch information is recorded on a user extension area included in recording control information.

4. The recording apparatus according to claim 1, wherein the switch information is recorded as reproduction control information for the video stream so as to allow reproduction in which the content type is switched between the 3D video content and the 2D video content without referencing video data in the video stream.

5. A reproducing apparatus comprising:
an acquisition unit configured to acquire from a recording apparatus a video stream and switch information, the switch information indicating switching of a content type between a 3D video content and a 2D video content in the video stream, and the switch information having been generated from a switch indication detected with reference to the video stream in recording of the video stream;
a reproducing unit configured to reproduce the acquired video stream; and
a reproduction control unit configured to control reproduction of the acquired video stream on the basis of the switch information.

6. The reproducing apparatus according to claim 5, further comprising an information unit configured to inform a user of the switching of the content type between the 3D video content and the 2D video content on the basis of the switch information.

7. The reproducing apparatus according to claim 5, wherein the reproduction control unit, on the basis of the switch information, performs in advance a prerequisite process for switching the content type between the 3D video content and the 2D video content in the video stream.

8. The reproducing apparatus according to claim 5, wherein the reproduction control unit controls reproduction of the video stream such that the 3D video content is reproduced on the basis of a method of displaying the 3D video content, the method being specified by the switch information.

9. The reproducing apparatus according to claim 5, wherein the reproduction control unit controls reproduction of the video stream such that one of the 3D video content and the 2D video content in the video stream is reproduced on the basis of the switch information.

10. The reproducing apparatus according to claim 9, wherein the reproduction control unit controls the reproduction of the video stream such that one of the 3D video content and the 2D video content in the video stream is reproduced on the basis of the ratio of content types in the video stream.

11. A recording/reproducing system, comprising:
a recording apparatus; and
a reproducing apparatus,
wherein the recording apparatus includes:
an acquisition unit configured to acquire a video stream,
a switch indication detecting unit configured to detect a switch indication with reference to the acquired video stream, the switch indication indicating switching of a content type between a 3D video content and a 2D video content,
a switch information generating unit configured to, on the basis of the detected switch indication, generate switch information, the switch information indicating switching of the content type between the 3D video content and the 2D video content in the video stream, and
a recording unit configured to record the switch information while correlating the switch information with the acquired video stream, and
wherein the reproducing apparatus includes:
an acquisition unit configured to acquire from the recording apparatus the video stream and the switch information, the video stream and the switch information having been recorded while being correlated with each other,
a reproducing unit configured to reproduce the acquired video stream, and
a reproduction control unit configured to control reproduction of the acquired video stream on the basis of the switch information.

12. A recording medium comprising recorded thereon a video stream and switch information, the switch information having been generated from a switch indication detected with reference to the video stream in recording of the video stream, and the switch information having been recorded while being correlated with the video stream, as information indicating switching of a content type between a 3D video content and a 2D video content, so as to allow reproduction in which the content type is switched between the 3D video content and the 2D video content without referencing video data in the video stream.

13. A program for causing a computer to execute a recording method, the recording method comprising the steps of:
acquiring a video stream;
detecting, with reference to the acquired video stream, a switch indication, the switch indication indicating switching of a content type between a 3D video content and a 2D video content;
generating, on the basis of the detected switch indication, switch information, the switch information indicating switching of the content type between the 3D video content and the 2D video content in the video stream; and
recording the switch information while correlating the switch information with the acquired video stream.

14. A program for causing a computer to execute a reproducing method, the reproducing method comprising the steps of:
acquiring from a recording apparatus a video stream and switch information, the switch information indicating switching of a content type between a 3D video content and a 2D video content in the video stream, and the switch information having been generated from a switch indication detected with reference to the video stream in recording of the video stream;
reproducing the acquired video stream; and
controlling, in the reproducing step, reproduction of the acquired video stream on the basis of the switch information.
